(19) United States
(12) Patent Application Publication
(10) Pub. No.: US 2020/0384401 A1
(43) Pub. Date: Dec. 10, 2020

(54) Filter Leaf Bag Protector

(71) Applicant: Genesis Alkali Wyoming, LP, Philadelphia, PA (US)

(72) Inventor: David C. Jackson, Rock Springs, WY (US)

(73) Assignee: Genesis Alkali Wyoming, LP, Philadelphia, PA (US)

(21) Appl. No.: 16/894,689

(22) Filed: Jun. 5, 2020

Related U.S. Application Data
(60) Provisional application No. 62/858,649, filed on Jun. 7, 2019.

(51) Int. Cl. B01D 46/00; B01D 46/10

(52) U.S. Cl. CPC B01D 46/0098; B01D 46/10

(57) ABSTRACT

A protective shield for filter leaf bags utilized in a filtration system is disclosed. In a particular embodiment, the protective shield comprises an upper shield surface comprising an elongated strip having securing ring proximate to a mid-point of the strip. The protective shield embodiment further comprises a forward side strip and a rear side strip extending downwardly and generally perpendicularly to the upper shield surface. When installed over the upper portion of the filter bag, the protective shield deflects liquid streams away from the upper portion of the filter bag decreasing damage and prolonging bag life.

### CROSS-REFERENCE TO RELATED APPLICATIONS

This application claims priority to U.S. Provisional Application No. 62/858,649 (“the '649 Application”) filed Jun. 7, 2019. The '649 Application is hereby incorporated by reference in its entirety for all purposes, including but not limited to, all portions describing the protective shield of the present invention and the embodiments disclosed, those portions describing filter bags and filtration systems in general as background and for use with specific embodiments of the present invention, and those portions describing other aspects of the protective shield that may relate to the present invention.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

### 1. Field of the Invention

The present invention relates to a protective device for a filter bag. More particularly, the present invention relates to a protective shield for preventing damage to filter leaf bags from high pressure wash systems.

### 2. Description of the Related Art

Pressure leaf filters are known in the art and are typically utilized for processes with high flow rates and low solids percentages. Filter leaf bags are designed to fit over each filter leaf. These filter leaf bags can be made of several different materials. As shown in FIG. 2, one problem with these designs is that certain processes can cause holes to be worn in the bags.

### BRIEF SUMMARY OF THE INVENTION

The present invention is a protective shield for filter leaf bags utilized in a filtration system. In a particular embodiment, the protective shield comprises an upper shield surface comprising an elongated strip having securing ring, preferably proximate to a mid-point of the strip. The securing ring allows a securing mechanism from the filter leaf (generally, but not limited to a bolt coupling) to pass through the shield thereby holding the shield in place during operation. The protective shield embodiment further comprises a forward side strip and a rear side strip extending downwardly and generally perpendicularly to the upper shield surface. In preferred embodiments, at least one bottom corner of the forward side strip extends angularly outward from the general perpendicular position of the forward side strip.

Additional advantages of the invention are set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

A better understanding of the present invention can be obtained when the following detailed description of the disclosed embodiments is considered in conjunction with the following drawings in which:

FIGS. 1 A, B and C which are plan, elevation, and end views, respectively, of an embodiment of a protective shield;

FIG. 2 is a top view of the prior art filter leave bag assembly showing a filter leave bag with substantial damage;

FIG. 3 is an elevation view of an embodiment of the protective shield installed on a filter leave assembly;

FIG. 4 is a perspective view of an embodiment of the protective shield installed on a filter leave assembly;

FIG. 5 is a top view of an embodiment of the protective shield installed on a filter leave assembly;

FIG. 6 is a perspective view of an embodiment of the protective shield; and

FIG. 7 is a perspective view of the underside of an embodiment of the protective shield.

### DETAILED DESCRIPTION OF THE INVENTION

The present invention is a protective shield for filter leaf bags utilized in a filtration system. In a particular embodiment, the present invention comprises an upper shield surface 14 comprising an elongated strip having securing ring 12, preferably proximate to a mid-point of the strip. The securing ring 12 allows a securing mechanism from the filter leaf (generally, but not limited to a bolt coupling) to pass through the shield 10 thereby holding the shield 10 in place during operation. The protective shield 10 embodiment further comprises a forward side strip 16 and a rear side strip 18 extending downwardly and generally perpendicularly to the upper shield surface. In preferred embodiments, at least one bottom corner of the forward side strip extends angularly outward from the general perpendicular position of the forward side strip. In preferred embodiments, the protective shield is manufactured from stainless steel materials.

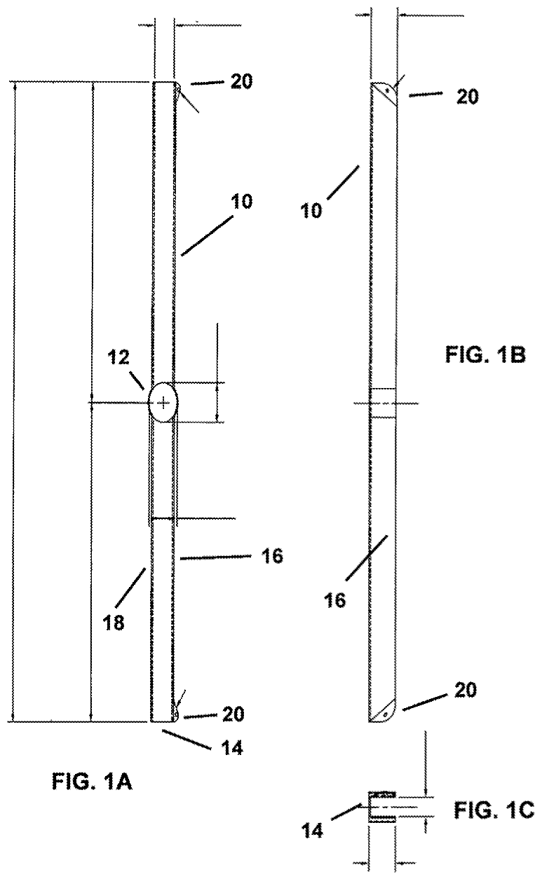

As shown in FIGS. 1 A, B, and C, a preferred embodiment of the protective shield 10 comprises an upper shield surface 14, a securing ring 12, a forward side strip 16 with extended corner segments 20, and a rear side strip 18. As will now be recognized by those of skill in the art, the dimensions of the protective shield 10 can vary with the particular size and configuration of the filter leaves and the filtration system in which the protective shield 10 is utilized. Preferably, the length of shield 10 should be such that the shield covers the direct impact zone of the wash water (or other fluid wash). That is, the shield 10 should extend to cover the horizontal portions of the filter leaf where the water wash spray typically contacts the top of the filter leaf and can create damage. Preferably, the protective shield is dimensioned to fit snuggly over the upper portion of a filter leaf over the bag. Preferably, the width of the shield 10 is no more than 0.5 inches wider than the width of the filter leaf with bag, more preferably no more than 0.25 inches wider, and even more preferably no more than 0.125 inches wider. In particular embodiments, the length of shield 10 is between about 3′ 4″ and 3′ 8″ inches and the width is about 1.25″ to 1.75″.

Securing ring 12 can be simply the interior edge portions of a hole cut into the upper shield surface or alternatively a ring like structure can be added surrounding the hole to increase structural integrity. The securing ring can be oval, circular, or other shape that allows for accommodation of the securing mechanism. In one preferred embodiment, the securing ring is oval with a long axis of about 2.5″ and a short axis of between about 1.25″ to 1.75″ to match the width of the shield. In preferred embodiments, the forward side strip 16 and the rear side strip 18 extend about 1.625″ outwardly from and generally perpendicularly to the upper shield surface 14.

Corners 20 preferably are bend outwardly to help get the filter bag installation started. In a preferred embodiment, the corner 20 is angled outwardly at about a 30 degree angle. Some embodiments will include a small hole in the angled portion of the corner to facilitate tying down bags. In a preferred embodiment, the corner 20 comprises a hole of about 0.25″.

As one of skill in the art will now recognize, the protective shield should be manufactured from materials compatible with the process in which the shield and accompanying filter leaves are utilized to prevent corrosion and process contamination. In preferred embodiments, the protective shield 10 is manufactured of stainless steel, but carbon steel or even aluminum could be utilized depending upon the process. The thickness of the material utilized to make the shield is important. As a person of skill in the art will now recognize, a balance needs to be made using material thick enough to make the shield 10 strong so it will not warp under the process forces, but thin enough to minimize excess weight. In a preferred embodiment, the material utilized to manufacture the shield 10 has a thickness of between about 0.0625 and 0.09375 inches.

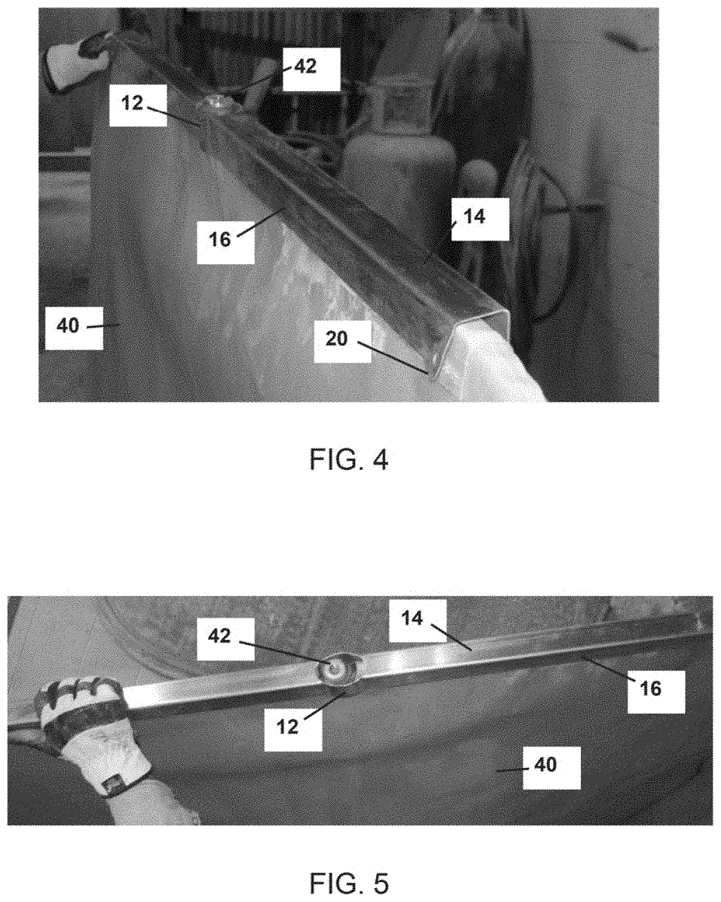

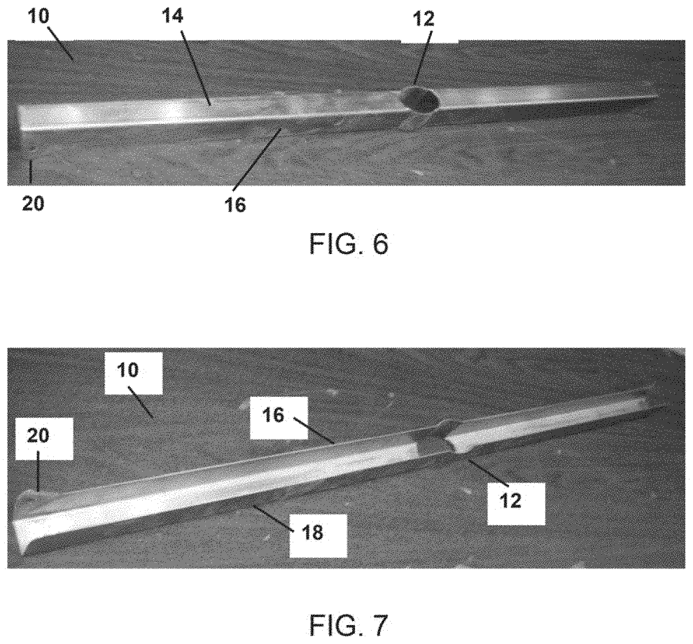

As shown in FIGS. 3, 4 and 5, the filter leafs 40 securing mechanism 42 preferably projects upwardly through the securing ring 12 once the protective shield 10 is in place. In most cases, the filter leaf's securing mechanism 42 will comprise a bolt coupling.

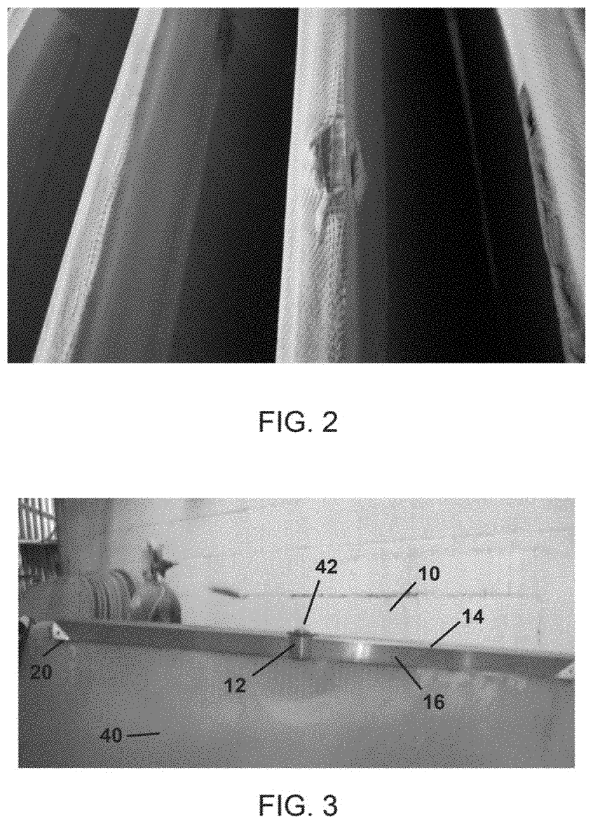

The protective shield 10 deflects spray from high pressure wash systems which are commonly utilized with filter leave filtration systems. Without the protective shield 10, the filter bags can become worn and frayed at the upper portion during use (See for example, the damage to bag shown in FIG. 2). The protective shield 10 prolongs the life of the filter bag by deflecting the damaging high-pressure streams.

As can be seen from the figures, including the dimensions disclosed thereon, a person of ordinary skill in the art could now manufacture and use the disclosed protective shield. A person of ordinary skill in the art would recognize that the precise dimensions and the materials of construction for the protective shield can depend upon the filtration system in which the shields are being utilized.

While the terms used herein are believed to be well-understood by one of ordinary skill in the art, definitions are set forth to facilitate explanation of certain of the presently-disclosed subject matter.

Following long-standing patent law convention, the terms “a”, “an”, and “the” refer to one or more when used in this application, including the claims. Thus, for example, reference to “a window” includes a plurality of such windows, and so forth.

Unless otherwise indicated, all numbers expressing quantities of elements, dimensions such as width and area, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of a dimension, area, percentage, etc., is meant to encompass variations of in some embodiments plus or minus 20%, in some embodiments plus or minus 10%, in some embodiments plus or minus 5%, in some embodiments plus or minus 1%, in some embodiments plus or minus 0.5%, and in some embodiments plus or minus 0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter. With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, S, C, and/or O” includes A, S, C, and O individually, but also includes any and all combinations and subcombinations of A, S, C, and O.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. The foregoing disclosure and description are illustrative and explanatory thereof, and various changes in the details of the illustrated apparatus and construction and method of operation may be made without departing from the spirit in scope of the invention which is described by the following claims.

We claim:

1. A protective shield for a filter leaf bag comprising:
an upper shield surface comprising an elongated strip having at least one securing ring within the strip;
a forward side strip and a rear side strip extending downwardly and generally perpendicularly to the upper shield surface;
whereby when installed over the upper portion of the filter bag, the protective shield deflects liquid streams away from the upper portion of the filter bag.

2. The protective shield of claim 1 wherein the securing ring is proximate to the midpoint of the upper shield surface.

3. The protective shield of claim 1 wherein the securing ring has a generally oval shape with a long axis of the oval running generally parallel with the forward and rear side strips.

4. The protective shield of claim 3 wherein the long axis of the securing ring is about 2.5 inches in length.

5. The protective shield of claim 1 wherein at least one outside corner is bent outwardly to facilitate loading a filter leaf.

6. The protective shield of claim 5 wherein the outside corner is bent outwardly at about a 30 degree angle.

7. The protective shield of claim 5 wherein the angled corner includes a hole to assist in securing a filter bag.

8. The protective shield of claim 5 wherein the outside corner has been rounded with about a 1 inch radius.

9. The protective shield of claim 1 wherein the shield has an overall length of between about 3.67 feet and about 3.33 feet.

10. The protective shield of claim 1 wherein a width of the shield between the forward side strip and the rear side strip is between about 1.25 inches and about 1.75 inches.

11. The protective shield of claim 1 wherein the shield is constructed from stainless steel.

12. The protective shield of claim 1 wherein the upper shield surface, the front side strip and the rear side strip have a thickness of at least about 1/16 inch.

13. A protective shield for a filter leaf bag comprising:
an upper shield surface comprising an elongated strip of stainless steel having a length of between about 3.67 and about 3.33 feet, and a width of between about 1.25 and 1.75 inches;
a securing ring for facilitating attachment to a filter leaf bag, the securing ring being proximate to a mid-point of the upper shield surface having a generally oval configuration with a long axis of the oval being parallel to the upper shield surface;
a forward side strip and a rear side strip extending downwardly and generally perpendicularly to the upper shield surface, the forward and rear side strips having a length generally equivalent to the upper shield surface and the forward side strip having corners bent outwardly at about a 30 degree angle;
whereby when installed over the upper portion of the filter bag, the protective shield deflects liquid streams away from the upper portion of the filter bag.
